(19) United States
(12) Patent Application Publication
(10) Pub. No.: US 2002/0027190 A1
(43) Pub. Date: Mar. 7, 2002

(54) Device for electronic targeting evaluation of shots fired on a shooting range

(76) Inventor: Ulrich Hellak, Rottenburg (DE)

Correspondence Address: STRIKER, STRIKER & STENBY, 103 East Neck Road, Huntington, NY, 11743, US

(21) Appl. No.: 09/945,593

(22) Filed: Sep. 4, 2001

(30) Foreign Application Priority Data
Sep. 5, 2000 (DE) 100 43 523.8

(51) Int. Cl. H01J 40/14

(52) U.S. Cl. 250/222.1

(57) ABSTRACT

The device for electronic targeting evaluation of shots fired on a shooting range includes transmitter modules (36) and reception modules (35), which are arranged around a target plane (41) to form a frame (40). The transmitter modules (36) produce a light beam grid with vertical sensor beams (37) and horizontal sensor beams (38), which are detected by the reception modules (35) and analyzed in a computer (47) connected with a control unit (46) to determine the effect of an object (48), such as a bullet, on the sensor beams. In this way the exact position at which the object (48) hits the target plane (41) can be accurately determined.

### BACKGROUND OF THE INVENTION

1. Field of the Invention

The present invention relates to a device for electronic targeting evaluation of shots fired on a shooting range and, more particularly, to a device for electronic targeting evaluation of shots fired on a shooting range, which has a sensor arrangement for detecting the positions of the hits in the vicinity of the target or targets.

2. Description of the Related Art

For electronic targeting evaluation the holes shot in the vicinity of a target can be electrooptically detected, or detected in other ways, in order to establish the positions of the holes in relation to a target or targets.

So that police will correctly use firearms in actual dangerous situations, video scenes of realistic dangerous situations are employed for education of the police. If firearms are required in these dangerous situations, the respective positions of the hits in the vicinity of the target or targets must be determined simultaneously, or as soon as possible, while the video scenes are running. The further progress of the video scenes depends on the positions that are hit in the vicinity of the targets. In order to provide this type of interactive training, the position of the hits must be determined in relation to the target or targets during the running video scenes as fast and as accurately as possible and to proceed with the further processing.

### SUMMARY OF THE INVENTION

It is an object of the present invention to provide a device for electronic targeting evaluation of shots fired at a target or targets on a shooting range, which is suitable for larger target areas or surfaces and which permits as rapid as possible targeting evaluation.

According to the invention the device for electronic targeting evaluation of shots fired at a target or targets on a shooting range includes sensing means for detecting a hit at one of a predetermined locations in a target plane, wherein the sensing means includes a plurality of transmitter elements and sensor elements, respective groups of the transmitter elements are accommodated in corresponding transmitter modules arranged in succession along a first X-axis and along a first Y-axis in the target plane, respective groups of the sensor elements are accommodated in corresponding reception modules arranged in succession along a second X-axis opposite to the first X-axis along which the transmitter modules are arranged and also along a second Y-axis opposite to the first Y-axis along which said transmitter modules are arranged; the transmitter modules and the reception modules are arranged along the first and second X-axis and the first and second Y-axis to form a frame around the target plane; and the transmitter elements and sensor elements of the corresponding transmitter modules and the corresponding reception modules are controlled synchronously according to a multiplex method; and computer means for determining the effect of a bullet or a shot producing the hit on at least two of the sensor beams in cooperation with the sensing elements of the reception modules, in order to establish the position of the hit.

Generally, according to the invention, a frame comprising the transmitter and reception modules encloses the target plane. The vertical and horizontal sensor beams are propagated in the target plane. The sensor beams form an XY grid, so that a bullet or shot penetrating the XY grid causes an interruption of at least one of the horizontal and vertical sensor beams. A computer connected with the sensor elements can evaluate the interrupted sensor beams in a fraction of a second and will then be available for additional control operations. For example, it can be established with electronic evaluation of hits whether or not the trained person has reacted correctly in concrete dangerous situations and whether or not a shot has hit the correct area, for example the leg or arm of a perpetrator or attacker displayed in the video scene.

The preferred embodiment of the invention has several reception modules arranged in succession along the second X-axis and along the second Y-axis, on which sensor beams generated by transmitter modules arranged on the opposite side of the frame can impinge. The reception modules and the transmitter modules are preferably identically constructed and have a plurality of electrooptic reception and transmitter elements arranged in series. The entire electronic evaluation device can be adjusted in its dimensions in a simple manner, as required, because of its modular structure. For a larger frame simply a larger number of modules are used than for a smaller frame.

It is particularly advantageous to produce the vertical sensor beams and the horizontal sensor beams by means of light emitting diodes or laser diodes, which thus form a vertical and horizontal light array in the target plane. The spacing of the sensor beams is thus selected so that the smallest bullet or short used can still be reliably detected.

Each transmitter and reception module can be equipped advantageously with e.g. 32 transmitter elements and 32 reception elements, which are simultaneously controlled or synchronized with each other. The transmitter and receiver modules can be controlled in parallel so that, for example, the same transmitter elements in all transmitter modules can be simultaneously controlled. The control work or effort is reduced because of that feature. As high a scan rate is thus attained for a larger target plane with many modules as for a smaller frame.

Additional very advantageous embodiments of the invention are disclosed and claimed in the appended dependent claims.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a block diagram of an entire structure of the device for electronic evaluation of hits in the vicinity of a target;

FIG. 2 is a diagrammatic illustration of the principal structure of a reception module, as it is used as a device shown in FIG. 1; and

FIG. 3 is a diagrammatic representation of a horizontal cross-section through the target plane with two sensor arrangements.

### DETAILED DESCRIPTION OF THE INVENTION

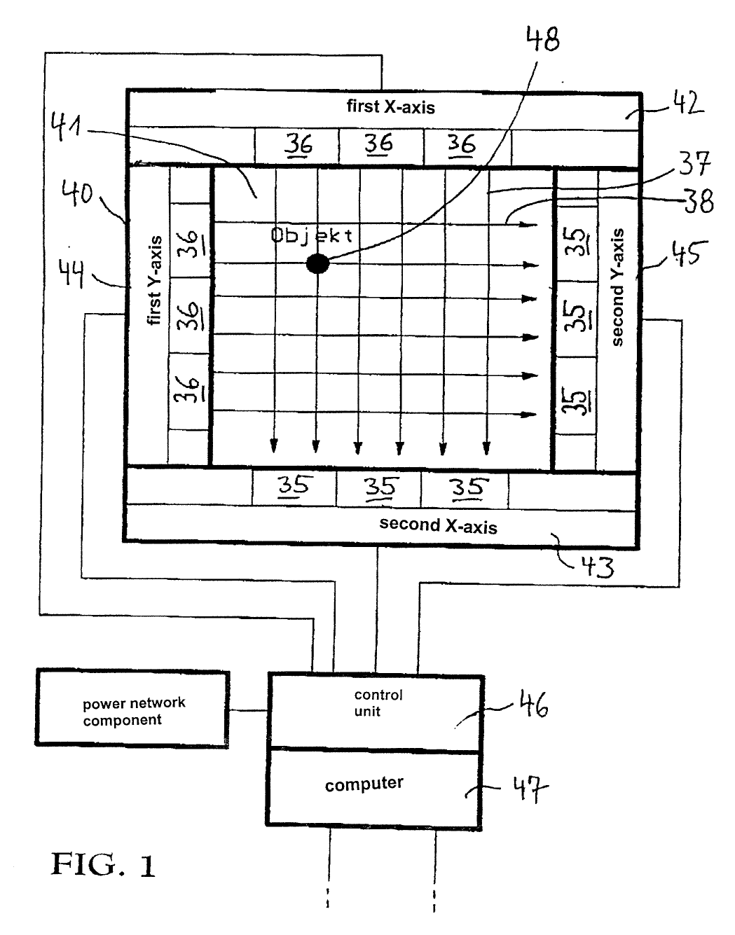

The block diagram shown in FIG. 1 shows the modular structure of a frame 40, which surrounds the target plane 41. The frame 40 has an upper or first X-axis 42 and a lower or second X-axis 43 spaced vertically from each other as well as a vertically extending first Y-axis 44 and second Y-axis 45. A plurality of identical reception modules 35 and identical transmitter modules 36 are arranged in succession along the X-axes and Y-axes respectively. The transmitter modules 36 include electrooptic transmitter elements that produce the vertical and horizontal sensor beams 37,38, so that a fine light grid is produced over the entire target plane 41.

A control unit 46 and a computer 47 control the transmitter modules 36 and analyze the influences on the sensor beams 37,38 by means of the reception modules 35. If an object 48, for example a bullet or a shot, penetrates the target plane 41 in an arbitrary position, at least two of the sensor beams, namely one horizontal and one vertical sensor beam, are interrupted by the object. The particular horizontal and vertical sensor beam or beams, which are interrupted by the object, are determined by a reception module 35 that is arranged along the X-axis and by another reception module 35 that is arranged along the Y-axis. In this way the position that the bullet has hit the target plane can be determined with great accuracy.

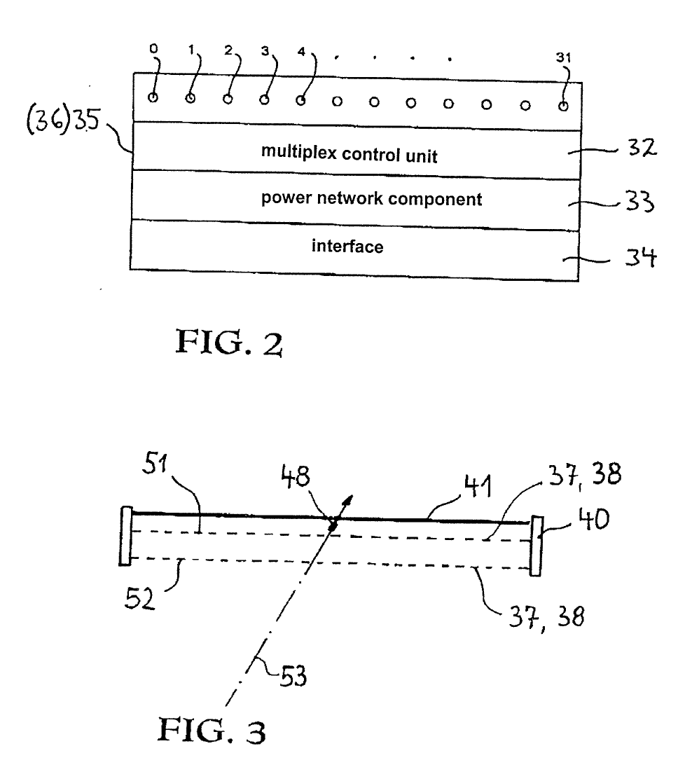

In FIG. 2 the structure of a reception module 35 is illustrated. The reception modules 35 each have 0 to 31 electrooptic elements acting as sensor elements. The transmitter modules 36 used in the frame 40 shown in FIG. 1 are constructed in the same manner as the reception modules 35 shown in FIG. 2. They have an equal number of electrooptic elements 0 to 31, which are however formed as transmitter elements that each propagate a sensor beam.

In addition to the electrooptic elements 0 to 31 the reception module 35 is equipped with a multiplex control unit 32, which is provided with current from a power network component 33 arranged in the module. The control unit 46 shown in FIG. 1 is connected to the reception module or multiplex control unit 32 by means of an interface 34.

During assembly of the transmitter and reception modules it is especially important to arranged the electrooptic elements exactly in position and especially to position the transmitter elements 0 to 31 of the transmitter module 36 exactly accurately so that exactly parallel horizontal and vertical sensor beams 37, 38 can be produced with great accuracy in the frame 40. The transmitter elements formed as light emitting diodes have an optical lens or other focusing devices, which produce sensor beams that are aligned as exactly as possible, each having a minimum scattering angle. Good results could be obtained with laser diodes, which have a switching time of less than 20 nsec. The beam was focused so that it had a half angle that was smaller than a 2°

An analogous evaluation of the sensor signals can occur, for example, by partially covering the reception or sensor element in 10% increments or steps, so that the accuracy of the location of the hits on the target plane is increased by a factor of 10.

The positions of the hits on the target plane by bullets or shots having a speed of 500 m/sec and more can be accurately established with the electronic evaluation device according to the invention. The bullet length, for example, can be between 10 to 15 mm. The evaluation device can have a length of up to 10 m in the target plane, because of the modular structure of the frame 40 of FIG. 1 without more. The hit positions of hits by bullets or shots on the target plane 41 that have diameters of only 5 mm may be reliably determined with transmitter and reception elements arranged suitably close to each other. The scan time for each module can be from 10 to 20 microseconds, i.e. the electrooptic elements 0 to 31 can be scanned with a cycle time of from 10 to 20 microseconds.

The scan times are minimized because all the transmitter modules and reception modules along the X-axis and Y-axis are operated in temporal and functional synchronization. Each module is a complete stand-alone operating unit, which is completely decoupled galvanically, has its own current source and its own control unit for evaluation of the sensors. The interface 34 is an electrooptic interface.

The evaluated data can be conducted to other systems for further processing by means of the control unit 46 (FIG. 1) and the computer 47. This data may be used to control a video scene projected on the target plane 41, for example, that show when a projected attacker is hit by a bullet in a dangerous situation. The video scene showing the dangerous situation can then continue according to the position that the bullet hit the target plane, in order to provide as realistic a training program for the police as possible.

According to FIG. 3 the device according to the invention can have sensor devices arranged parallel to each other in front of the target plane 41 in the vicinity of the target, which form two parallel sensor planes 51,52 with their transmitter and reception elements. Thus both sensor planes 51,52 can be used to determine the angle of the shooting direction 53 from the established coordinates of the hit on the target plate 41. These sensor planes 51,52 can be arranged behind or in front of the target plate in order to avoid parallax errors.

The disclosure in German Patent Application 100 43 523.8 of Sep. 5, 2000 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a device for electronic evaluation of shooting hits for a shooting range, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A device for electronic targeting evaluation of shots fired in the vicinity of a target or targets on a shooting range, said device for electronic targeting evaluation including
sensing means for detecting a hit at one of a number of predetermined locations in a target plane (41), wherein said sensing means comprises a plurality of transmitter elements and sensor elements, said transmitter elements are arranged to produce a plurality of vertical sensor beams (37) and a plurality of horizontal sensor beams (38); respective groups of the transmitter elements are accommodated in corresponding transmitter modules (36) arranged in succession along a first X-axis (42) and along a first Y-axis (44) in the target plane (41), respective groups of the sensor elements are accommodated in corresponding reception modules (35) arranged in succession along a second X-axis (43) opposite to the first X-axis (42) along which the transmitter modules are arranged and along a second Y-axis (45) opposite to the first Y-axis (44) along which said transmitter modules are arranged; the transmitter modules (36) and the reception modules (35) are arranged to form a frame (40) around the target plane (41); and the transmitter elements and sensor elements of the corresponding transmitter modules and the corresponding reception modules are controlled synchronously according to a multiplex method; and
computer means (47) for determining the effect of a bullet or a shot producing the hit on at least two of the sensor beams (37,38) in cooperation with said sensing elements of said reception modules (35), in order to establish the position of the hit.

2. The device as defined in claim 1, wherein said transmitter modules (36) are constructed identical with each other and said reception modules (35) are constructed identical to each other.

3. The device as defined in claim 1, wherein the transmitter modules (36) containing the transmitter elements are arranged with the transmitter elements along the first X-axis (42) and along the first Y-axis (44) and the reception modules (35) containing the sensor elements are arranged with the sensor elements along the second X-axis (43) and along the second Y-axis (45) so that each of the sensor beams (37,38) propagated from the transmitter elements is received by a respective one of the sensor elements.

4. The device as defined in claim 1, wherein each of the transmitter modules (36) contains a predetermined number of the transmitter elements, each of said reception modules (35) contains a predetermined number of sensor elements and said predetermined number of sensor elements is equal to said predetermined number of transmitter elements.

5. The device as defined in claim 1, wherein said vertical sensor beams are parallel to each other, said horizontal sensor beams are parallel to each other and said horizontal beams and said vertical beams form two arrays of light beams.

6. The device as defined in claim 1, further comprising a central control unit (46) comprising means for controlling said transmitter elements of the transmitter modules (36) and said sensor elements of said reception modules (35).

7. The device as defined in claim 6, wherein each of the transmitter modules (36) contains a predetermined number of the transmitter elements, each of said reception modules (35) contains a predetermined number of sensor elements, said predetermined number of sensor elements is equal to said predetermined number of transmitter elements, said transmitter elements and said sensor elements are addressable by said central control unit (46), each of said transmitter elements and said sensor elements is associated with an address for said central control unit (46) and said central control unit (46) controls said transmitter elements and said sensor elements in said transmitter modules and said reception modules cyclically in succession from a first address to a last address.

8. The device as defined in claim 7, wherein said transmitter module (36) has 32 of said transmitter elements and said reception module (35) has 32 of said sensor elements.

9. The device as defined in claim 1, wherein each of said transmitter modules (36) and said reception modules (35) has an operating unit and said operation unit comprises a power network component (33), a multiplex control unit (32) and an interface (34) for connection to a central control unit (46).

10. The device as defined in claim 1, wherein the transmitter elements and the sensor elements comprise electrooptic elements (0 to 31) having switching times of less than 20 nsec, and said electrooptic elements comprise laser diodes or PIN diodes.

11. The device as defined in claim 10, wherein said electrooptic elements focus with a half angle of less than 2°.

12. The device as defined in claim 10 or 11, further comprising means for partially covering the reception elements in 10 percent increments to increase accuracy for determining the position of the hit.

13. The device as defined in claim 1, wherein said transmitter modules and said reception modules have scan rates in a range of from 10 to 20 microseconds.

14. The device as defined in claim 1, further comprising two parallel sensor arrangements in front of or behind said target plane in the vicinity of said target or targets, said sensor arrangements comprise a plurality of sensor elements arranged in two parallel sensor planes and an exact position of said hit is determined in the target plane from sensor data from both of said two parallel sensor arrangements.
